(19) United States
(12) Patent Application Publication
(10) Pub. No.: US 2022/0324470 A1
(43) Pub. Date: Oct. 13, 2022

(54) MONITORING OF AN AI MODULE OF A VEHICLE DRIVING FUNCTION

(71) Applicant: Volkswagen Aktiengesellschaft, Wolfsburg (DE)

(72) Inventors: Peter Schlicht, Wolfsburg (DE); Rene Waldmann, Hepberg (DE)

(21) Appl. No.: 17/613,018

(22) PCT Filed: Apr. 15, 2020
(86) PCT No.: PCT/EP2020/060593

§ 371 Date: Nov. 19, 2021

(30) Foreign Application Priority Data
May 9, 2019 (DE) 10 2019 206 720.4

(51) Int. Cl. B60W 50/04; G05B 13/02; B60W 60/00

(52) U.S. Cl. CPC B60W 50/045; G05B 13/0265; B60W 60/001; B60W 2050/0088

(57) ABSTRACT

The monitoring of an AI module of a vehicle driving function, the monitoring being performed using a generative-discriminative situation evaluation which represents a control mechanism for the AI modules along the processing chain of the driving function. The control mechanism is in the form of a monitoring unit for monitoring input and output data of a control module, in the form of an AI module, for semi-automatic or automatic driving.

### CROSS REFERENCE TO RELATED APPLICATION

The present application claims priority to International Patent App. No. PCT/EP2020/060593, to Schlicht et al., titled “Monitoring of An AI Module of a Vehicle Driving Function”, filed Apr. 15, 2020, which claims priority to German Patent App. No 10 2019 206 720.4, filed May 9, 2019, the contents of each being incorporated by reference in their entirety herein.

### FIELD OF TECHNOLOGY

The present disclosure relates to a method and an apparatus for monitoring an AI module that forms part of a processing chain of a partly automated or automated vehicle driving function.

### BACKGROUND

The use of AI modules for handling highly complex situations is inevitable when developing functions for partially automated or automated driving. To sustainably develop and deploy these functions, monitoring the execution of the AI modules is imperative. This applies both to the training phase of the AI modules, where one looks for exceptional cases, so-called corner cases, e.g., typical situations of limited correctness of the module output, and to productive use, where one has to perform redundancy and system monitoring to assess the trustworthiness of AI module decisions.

Currently, redundancy and system monitoring mainly relies on model-intrinsic confidences, e.g., the interpretation of softmax excitations, or on plausibility checks that use analytical methods. The identification of exceptional cases, e.g., corner cases, is based primarily on functional drops, e.g., cases in which an AI module or the corresponding function terminates, or target-actual comparisons.

Model-intrinsic confidences are subject to a training bias and can be highly inaccurate, meaning that adversarial examples, namely small changes in the data signal resulting in a change of model output, lead to misclassifications with high intrinsic confidence.

Furthermore, plausibility checks using analytical methods require high potency plausibility check functions. These functions are either extremely defensive, thus preventing high-frequency use of the AI modules, or they cannot be realistically constructed.

US 2016/0335536 A1 relates to a hierarchical neural network and a classifying learning method, and a discriminating method based on the hierarchical neural network. A hierarchical neural network apparatus therein comprises a weight learning unit for generating loosely coupled parts by forming couplings between partial nodes in the hierarchical network based on a verification matrix of an error-correcting code and for learning weights between the coupled nodes. Furthermore, the apparatus comprises the hierarchical neural network having an input layer, at least one intermediate layer and an output layer, wherein each of these layers has nodes, and a discrimination processor for solving classification problems or regression problems using the hierarchical neural network whose weights between the nodes are updated with the weights the weight learning unit has learned.

US 2016/0071024 A1 relates to a multimodal data analysis device including instructions that are embodied in one or more non-transitory machine-readable storage media, wherein the multimodal data analysis device effects, by means of a computer system having one or more computer devices, that at least two different modalities are used to access a quantity of time-variable instances of multimodal data, wherein each instance of the multimodal data has a different temporal component and, using a deep-learning architecture, algorithmically learns a feature representation of the temporal component of the multimodal data.

The publication by I. J. Goodfellow et. al.: “Generative Adversarial Nets,” NIPS 2014 (https://papers.nips.cc/paper/5423-generative-adversial-nets) describes a method for evaluating generative models using an adversarial process, wherein two models are trained simultaneously, namely a generating model G, which generates data of a data distribution, and a discriminating model D, which determines the probability that a data set to be discriminated is part of training data instead of data of the generating model. In other words, the method comprises two neural networks which perform a zero-sum game. One network, the generator, creates candidates and the second neural network, the discriminator, evaluates said candidates. Typically, the generator maps from a vector of latent variables to the desired result space. The goal of the generator consists in learning to generate results according to a certain distribution.

The discriminator, on the other hand, is trained to distinguish the results of the generator from the data based on the real, specified distribution. Thus, the objective function of the generator consists in producing results that the discriminator cannot distinguish. In this way, the generated distribution is to gradually become aligned with the real distribution.

### SUMMARY

Aspects of the present disclosure are to provide a method and an apparatus for improved monitoring of an AI module that forms part of a processing chain of a partially automated or automated driving function of a vehicle.

These aspects are achieved by the independent claims found below. Other embodiments of the present disclosure are the subject matter of the subclaims.

In some examples, a method is disclosed for monitoring the input data stream of an AI module that forms part of a processing chain of a partially automated or automated driving function of a vehicle by means of a monitoring module formed by a generative adversarial network including a generator and a discriminator, wherein the method has a training phase and an inference phase, and
in the training phase, also referred to as the learning phase, training of the monitoring module occurs using real training data and generated false training data generated by the generator, both of which are fed to the discriminator, which learns, as an output, a distance between the real training data and the generated training data,
   and
in the inference phase, the AI module is evaluated by the monitoring module in that, based on the real input data stream, the trained AI module generates output signals suitable for the driving function and in that, in parallel with this, the real input data stream is fed to the discriminator of the trained monitoring module, and the discriminator determines distances therefrom that are used for evaluating the input data stream and for monitoring the output signals of the AI module.

The numerical value expressing the distance, which is a real number, is interpreted as the distance of the input data to the training data set, so that the situation underlying the real input data stream of the inference phase can be evaluated using this numerical value.

In other words, if, for example, the numerical value of a distance d is normalized to the interval [0, 1], a numerical value of the distance of d≤0.5 could mean that the input data are “real”, while a numerical value of d>0.5 means that the input data are, so to speak, “false,” i.e. they were not part of the training data set. The latter suggests an environmental situation that has not been trained or learned, such as a corner case. The definition of the value interval is not limited to the above-mentioned interval, rather, other intervals and assignments of the distance d to the respective interval are possible; however, it must be apparent from the distance d whether the currently evaluated situation is typical for the learned training data sets or not, i.e. whether the present case deviates from the learned training data sets.

Preferably, the generator uses a background data source to generate the false training data that are fed to the discriminator. The background data source can be formed, for example, by a suitable random number generator.

In some examples, a training loss with respect to the real training data may be determined from the distance, which training loss is used to train the generator and the discriminator of the monitoring module.

In some examples, an apparatus is disclosed for monitoring the input data stream of an AI module, wherein the apparatus is configured and designed for carrying out the method explained herein, comprising
an AI module that forms a part of a processing chain of a partially automated or automated driving function of a vehicle and on the basis of real input signals generates output signals for use in the driving function, and
a monitoring module that uses real input signals to generate a difference signal that is used for monitoring the input data stream of the AI module.

In some examples, a method is disclosed for monitoring the input data stream and the output data stream of an AI module that forms part of a processing chain of a partially automated or automated driving function of a vehicle comprises three monitoring modules, each formed by a generative adversarial network including a generator and a discriminator, wherein the method has a training phase and an inference phase, and wherein, in the training phase
the first monitoring module for monitoring the input data stream of the AI module is trained by real training data and false training data, wherein the false data are generated by the generator of the first monitoring module, and generates first difference signals,
the AI module is trained using real training data and ground truth data, and generates output signals,
the second monitoring module for monitoring the output data stream of the AI module is trained using output data of the AI module and false data, wherein the false data are generated by the generator of the second monitoring module, and generates a second difference signal,
the third monitoring module for monitoring the output data stream of the AI module is trained using ground truth data and false ground truth data, wherein the false ground truth data are generated by the generator of the third monitoring module, and generates a third difference signal,
   and in the inference phase, monitoring of both the input data stream into the AI module and the output data stream from the AI module occurs, wherein
a real input data stream is fed to the discriminator of the trained first monitoring module, and the discriminator determines distances therefrom which are used to evaluate the input data stream, and
the output data stream is fed to the discriminator of the trained second monitoring module, and the discriminator determines distances therefrom which are used to evaluate the output data stream, and/or
the output data stream is fed to the discriminator of the trained third monitoring module, and the discriminator determines distances therefrom which are used to evaluate the output data stream.

Therefore, in the inference phase, the first distance is used for evaluating the typicality of the real input data stream, for example, from an environmental sensor means, relative to the training data of the training phase; the second distance is used for evaluating the typicality of the output of the AI module relative to the output of the training; and the third distance is used for evaluating the typicality of the output of the AI module relative to seen ground truth from the training. With regard to the three distances, what was said about the distance in the first method applies here as well. In other words, the distances are a measure of whether the observed data stream is similar to or whether it deviates from the data streams during training. Thus, if the deviation is outside of a specification, it can be concluded that a situation has not been trained and must be responded to accordingly.

In some examples, the generators generate false training data using a respective background data source, and the data are fed to the discriminators of the respective monitoring modules.

In some examples, during the training phase, training losses with respect to the respective training data are determined from each of the three distances, and said training losses are used to train the generators and discriminators of the respective monitoring module.

In some examples, an apparatus is disclosed for monitoring the input data stream and the output data stream of an AI module that forms part of a processing chain of a partially automated or automated driving function of a vehicle, wherein the apparatus is configured and designed to carry out the method explained above, including
an AI module that forms part of a processing chain of a partially automated or automated driving function of a vehicle and on the basis of real input signals generates output signals for the driving function, and
three monitoring modules that use real input signals and the output signals of the AI module to generate respective distance signals which are used for monitoring the input data stream and the output data stream of the AI module.

### BRIEF DESCRIPTION OF THE DRAWINGS

Aspects of the present disclosure are explained below with reference to the drawings. In the drawings:

FIG. 1 shows an example of the training phase of a generative adversarial network applied to input signals, according to some aspects of the present disclosure;

FIG. 2 shows the inference phase, or the operational phase, of an AI application with the trained discriminator of FIG. 1, according to some aspects of the present disclosure;

FIG. 3 shows the training phase of a generative adversarial network including the AI application, wherein input signals and output signals of the AI application are monitored, according to some aspects of the present disclosure;

FIG. 4 shows the inference phase of the AI application with the trained discriminators of FIG. 3, according to some aspects of the present disclosure; and

FIG. 5 shows a schematic view of an application of a generative adversarial network in the processing chain of a driving function, according to some aspects of the present disclosure.

### DETAILED DESCRIPTION

Aspects of the present disclosure are directed to a generative-discriminative situation evaluation that provides a control mechanism for AI modules along the processing chain of an automated driving function.

A control mechanism may be implemented in the form of a monitoring unit for monitoring input and output data of a control module for partially automated or automated driving, which control module is implemented by an AI module.

This situation evaluation, which is to say the control mechanism, measures the data stream flowing into and out of an AI module and measures a distance of the reference data distribution with which the AI module was originally developed and trained.

The situation evaluation makes use of a preferably threefold generative-discriminative approach, which is developed during the development phase of the AI model and will be described in general terms below.

The development and monitored training of AI modules uses an iterative approach in which a module is presented with reference data and the resulting module output is compared to a so-called ground truth. A loss value, the loss, is calculated from the difference between the last two values and the module is adjusted in accordance with this loss.

The control unit for monitoring the AI module preferably includes three independent monitoring modules, the so-called generative-discriminative distance measurement modules, for measuring the distance to the training input, the distance to the training output and the distance to the training ground truth. Each of the three individual modules consists of a generator and a discriminator. The task of the generator is to create the most realistic data possible; namely, input, output, and ground truth. The task of the discriminator, on the other hand, is to distinguish between real data and generated data. Its output is consequently the learning of a measure for distinguishing between typical and atypical input and output data. This measure is then interpreted and used as a distance to the real data.

The discriminator of a distance measurement module is an AI module whose training is implemented during the training of the actual AI module of the driving function. The data used in and resulting from the training, namely input, output or ground truth, are used as training data for the respective discriminator. Additional training data for the discriminator are provided by the generator. The generator, in turn, makes use of a background data source, which is called latent space, and generates false training data therefrom.

It can itself also be an AI module, such as a GAN approach from the machine learning field, but also a simulation or an image search on the Internet.

At the time of execution, which is called inference, the control unit according to the present disclosure uses only the discriminators. At runtime, they then evaluate and monitor the distance of the incoming and outgoing data stream in the actual AI module of the driving function to the reference data set.

In the interest of computing efficiency or in cases where AI modules of the driving function are extremely well trained, it is possible to omit one of the two distance measurement modules for monitoring the output flow.

For the best possible monitoring of the correct functionality of AI modules, relationships between the typicality of a current module output with respect to reference ground truth data, on the one hand, and reference training outputs, on the other hand, should also be considered. This can potentially provide insight into a generalization capability of the AI module.

The distance measurement module, which is responsible for the input data stream of the AI module, can also be operated by itself. In other words, in its simplest embodiment, the control unit comprises only the distance measurement module for the input data stream; but this results in reduced performance.

The comprehensive approach of the control device according to the present disclosure with at least two distance measurement modules allows for monitoring relationships between incoming and outgoing data streams. Since the training of the individual modules can be carried out in parallel with the training of the actual AI module of the driving function without incurring any significant additional technical effort, this option represents a considerable savings potential compared to currently known solutions.

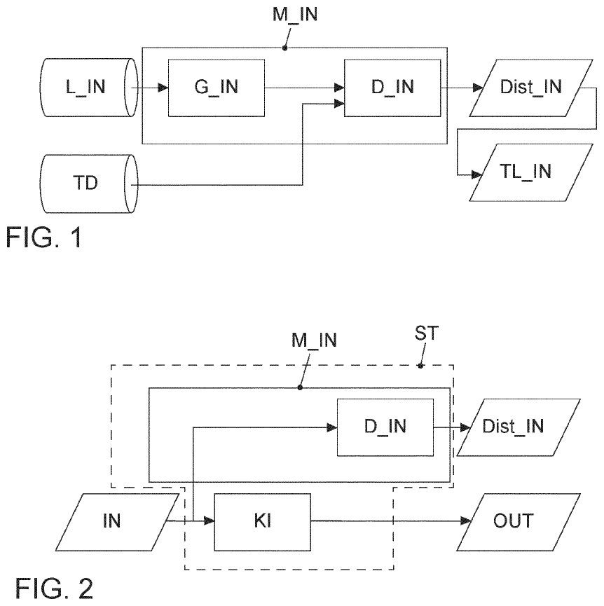

FIG. 1 shows a so-called generative-discriminative distance measurement module M_IN which determines a distance between training data TD and artificially generated data. The module M_IN is formed by a generative adversarial network, a technical term, abbreviated GAN, that stands for “Generative Adversarial Network,” which is described, for example, in the above-mentioned article by I. J. Goodfellow. The module M_IN comprises a generator G_IN that generates false training data from a background data source L_IN, the so-called “latent space for input data,” wherein the generator G_IN has the task of generating training data that are as realistic as possible. These false training data generated by the generator G_IN are fed to a discriminator D_IN, together with the real training data TD. It is the task of the discriminator D_IN to distinguish between the false training data of the generator G_IN and the real training data. For this, a distance Dist_IN between the real and the false training data is determined, which is a measure of the distance of the training data TD to the generated data. This distance Dist_1N is then used to determine a quantity called training loss TL_IN, which serves for training the module M_IN, so that the generator G_IN generates data based on the training loss TL_IN, which data become more similar to the training data TD, and the discriminator D_IN improves the discrimination between real and false data. Both the discriminator D_IN and the generator G_IN can be designed as AI modules.

FIG. 2 shows the application of the discriminator D_IN, as trained in FIG. 1, of the module M_IN in an AI module KI, for example, an AI module of a vehicle. A real input IN is fed to an AI module KI, which generates an output OUT. The input IN is usually formed by sensor signals from one or more environment sensors, which are processed in the AI module. The AI module KI consequently generates output signals OUT from these input signals IN, which are further processed in the controller during automated driving action. For example, the input signals IN can be the signals from a camera (not shown) and/or a radar sensor.

If the AI module KI is an object recognition module, the AI module KI is to recognize and determine, based on the received signals IN, the objects in the environment of the vehicle, so that such objects, their spatial arrangement, and the type of objects, for example, vehicle, pedestrian, or cyclist, are output as the output OUT of the AI module, wherein the type of objects represents a probability statement. This output OUT can then be fed to a scene recognition and scene prediction (not shown) so that, ultimately, an automated driving function (not shown) can be controlled.

The AI module KI may also be a lane recognition module that determines, based on the signals IN of the environment sensors, the lanes of the roadway on which the vehicle is located as its output OUT, whereby, when merging these results with the results of an object recognition, it is possible to determine which object is located in which roadway. The list of uses of AI modules in automated driving provided here should be regarded only as exemplary and not as complete.

In the application of FIG. 2, the input signals IN are fed to both the AI module KI but, in parallel, also to the discriminator D_IN of the trained distance measurement module M_IN. The trained discriminator determines based on the input signals IN a distance Dist_1N, which indicates the distance of the input signals IN from known trained situations, so that the distance signals IN determined in this way allow for deriving the statement as to whether the environment situation corresponds to a known situation. In this way, the output Dist_1N can be used for determining deviations of the input signals from known situations and for monitoring the AI module.

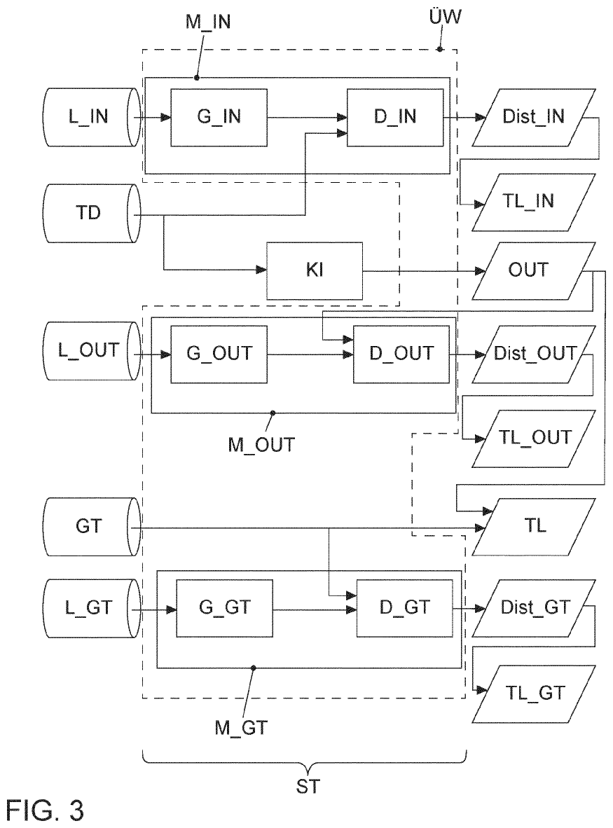

FIG. 3 shows a schematic view of the training phase of a control unit for full generative-discriminative situation evaluation, which illustrates a control mechanism for AI modules along the processing chain of an automated driving function, wherein the control mechanism is a program or control unit for monitoring input and output data of an AI control module for partially automated or automated driving.

In addition to the AI module KI, the illustrated control unit ST with AI module KI comprises three generative-discriminative distance measurement modules, namely the module M_IN for determining a distance to a training input, the module M_OUT for determining a distance to a training output, and the module M_GT for determining a distance to a training ground truth, wherein the modules will be explained in detail below.

The distance measurement module M_IN comprises a generator G_IN which generates false input training data that are as realistic as possible, wherein the generator G_IN makes use of a background data source L_IN, the so-called latent space, for generating the false training data. Further, the module M_IN comprises a discriminator G_IN which compares the false training data generated by the generator G_IN with real training data TD, and outputs a distance Dist_1N as an output of the distance measurement module M_IN, wherein the distance Dist_1N represents the distance of the false training data to the real training data, i.e. it is a measure of the expected affiliation of the current false data unit relative to the quantity of generated false data. A function called training loss TL_IN is determined based on the distance Dist_1N and the corresponding data, and said function is used for training the distance measurement module M_IN with the generator G_IN and the discriminator D_IN.

Since it is not sufficient to consider only input data, for example based on the environmental sensor means, for evaluating the behavior and functionality of an AI module KI of a partially automated or automated driving function, such as, e.g., a parking assistant or the like, the output and the so-called ground truth data of the AI module KI are also monitored.

Thus, the training data TD are also fed to the AI module KI that generates an output OUT therefrom, which, for example, is responsible for controlling a driving function. This output OUT of the AI module KI is fed to the discriminator D_OUT of a second generative-discriminative distance measurement module M_OUT. The second module M_OUT comprises a generator G_OUT which uses another background data source L_OUT for generating false training data, which are fed to the discriminator D_OUT. The discriminator D_OUT generates a distance Dist_OUT that is based on the real output data OUT of the AI module KI and the false training data generated by the generator G_OUT, wherein the distance Dist_OUT represents the distance of the false training data to the real output OUT of the AI module KI, i.e. it is a measure of the expected affiliation of the current false data unit relative to the quantity of generated false data. A function called training loss TL_OUT with respect to the output OUT of the AI module KI is determined on the basis of the distance Dist_OUT and the corresponding data, and this function is used for training the distance measurement module M_OUT with the generator G_OUT and the discriminator D_OUT.

To train the AI module KI itself, the output OUT is combined with ground truth data GT resulting in a loss function TL which can be used for training the AI module, wherein TL stands for “training loss”.

The ground truth data GT are fed to the discriminator D_GT of a third generative-discriminative distance measurement module M_GT. The third module M_GT comprises a generator G_GT which uses a third background data source L_GT for generating false training data which are fed to the discriminator D_GT. The discriminator D_GT generates a distance Dist_GT on the basis of the real ground truth data GT and the false training data generated by the generator G_GT, wherein the distance Dist_GT represents the distance of the false training data to real ground truth data GT, i.e. it is a measure of the expected affiliation of the current false data unit relative to the quantity of generated false data. A loss function TL_GT with respect to the ground truth data GT is determined based on the distance Dist_GT and the corresponding data, and this loss function is used for training the distance measurement module M_GT with the generator G_GT and the discriminator D_GT.

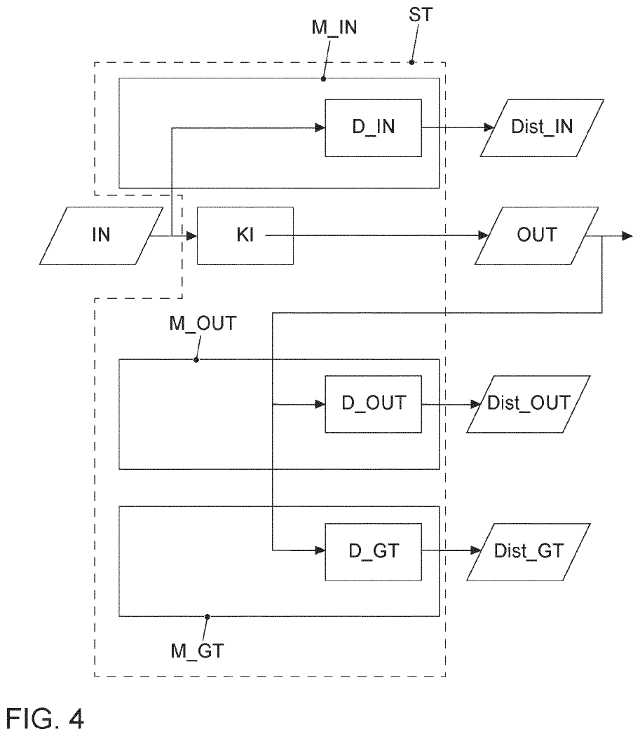

FIG. 4 shows the inference phase, i.e. the application phase, of the control unit ST with AI module KI, wherein only the discriminators D_IN, D_OUT and D_GT of the three modules M_IN, M_OUT and M_GT are used in the inference phase.

The input signals, for example from environmental sensor means, are fed as real input IN both to the AI module KI for processing and to the discriminator D_IN of the module M_IN, which is responsible for evaluating the input signals. The discriminator D_IN determines based on the input signal IN a first distance Dist_1N with respect to the input signals IN. The module output OUT is determined by the AI module KI on the basis of the input signal, and the module output OUT is further processed within the processing chain of the driving function, as symbolized by the arrow, and it is fed both to the discriminator D_OUT of the second distance measurement module M_OUT with respect to the output signal OUT and to the third distance measurement module M_GT with respect to the ground truth GT. In this way, distances Dist_OUT with respect to the output signal OUT of the AI module KI and Dist_GT with respect to the ground truth GT as shown in FIG. 3 are generated.

The distances Dist_1N, Dist_OUT and Dist_GT generated by the three distance measurement modules M_IN, M_OUT and M_GT monitor the data streams IN and OUT flowing into and out of the AI module KI and therefore provide information about the behavior of the AI module, in particular, if the data stream input IN is a non-trained situation, so that the output OUT of the AI module also does not correspond to a trained situation, which is reflected in the distances Dist_OUT and Dist_GT of the two discriminators D_OUT and D_GT. In this way, it is possible, for example, during operation of the control unit for monitoring an AI module KI of a driving function, to determine so-called corner cases, i.e. borderline cases, which were not taken into account in the simulation, i.e. the production of corresponding training data, since, as is well known, it is hardly possible to take into account all possible situations with respect to a partially automated or automated driving function.

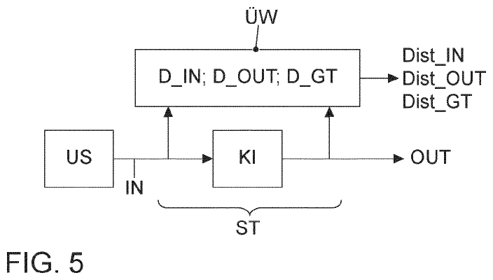

FIG. 5 shows an application of the control unit ST consisting of the AI module KI and the monitoring unit ÜW in a partially automated driving function of a vehicle; here intended as a non-restrictive example in the object recognition of the driving function “parking assistant.” The object recognition implemented by the AI module (AI) receives input data IN from environmental sensor means US, which may include cameras, radar, lidar, ultrasonic sensors, or the like. The AI module KI, which serves for object recognition, uses the input data IN fed to it to recognize objects, for example, other vehicles, pedestrians, traffic signs, trees, curb stones, etc., in the environment of the vehicle, and outputs these objects with corresponding properties, such as relative speed, position relative to the vehicle, etc., as output data (OUT) for further processing by other instances (not shown).

The monitoring unit ÜW monitors the input data stream IN into the AI module KI and the output data stream OUT from the AI module KI, wherein the monitoring unit ÜW is formed by the three discriminators D_IN, D_OUT and D_GT of the distance measurement modules M_IN, M_OUT and M_GT described in FIGS. 3 and 4. The discriminators D_IN, D_OUT, D_GT generate distances Dist_1N, Dist_OUT and Dist_GT which show the typicality of the input data stream and the output data stream of the AI module KI with respect to the corresponding training data. In a simpler form, not both discriminators D_OUT and D_GT are necessary in the monitoring module for monitoring the output data stream OUT of the AI module; if the quality of the training is sufficient, one of the mentioned discriminators can be omitted.

For each of the three distances Dist_1N, Dist_OUT and Dist_GT measured by the discriminators D_IN, D_OUT, D_GT, a respective threshold S_IN, S_OUT and S_GT can now be defined with the following specifications:

Dist_1N≤S_IN: Input data stream IN “real” in the sense of known, i.e. trained,

Dist_1N>S_IN: Input data stream IN “unknown” in the sense of not trained,

Dist_OUT≤S_OUT: Output data stream OUT “real”,

Dist_OUT>S_OUT: Output data stream OUT “unknown”,

Dist_GT≤OUT: Output data stream OUT “real”,

Dist_GT>OUT: Output data stream OUT “unknown”.

### REFERENCE SYMBOL LIST

ST Control unit with AI module
ÜW Monitoring module
M_IN Module for determining the distance of input data
G_IN Generator input data
D_IN Discriminator input data
L_IN Latent space input data
TD Training data
Dist_IN Distance input data
TL_IN Training loss input data
IN real input
KI AI module
OUT Output of the AI module
M_OUT Module for determining the distance of output data
G_OUT Generator output data
D_OUT Discriminator output data
L_OUT Latent space output data
Dist_OUT Distance output data
TL_OUT Training loss output data
M_GT Module for determining the distance of ground truth data
G_GT Generator ground truth data
D_GT Discriminator ground truth data
GT Ground truth data
L_GT Latent space ground truth data
TL Training loss OUT and GT
Dist_GT Distance ground truth data
TL_GT Training loss ground truth data
US Environmental sensor means

1-8. (canceled)

9. A method for monitoring the input data stream of an artificial intelligence (AI) module that forms part of a processing chain of a partially automated or automated driving function of a vehicle, comprising:
in a training phase, training a monitoring module using real training data and generated false training data generated by a generator;
feeding the real training data and false training data to a discriminator;
generating a distance between the real training data and the false training data;
in an inference phase, evaluating the AI module via a monitoring module;
generating, via the AI module, output signals configured for a driving function on the basis of the real input data stream;
feeding the real input data, in parallel with the generated output signals to the discriminator to determine distances that are used for evaluating the input data stream for driving functions.

10. The method according to claim 9, wherein the generated false training data is generated by a background data source that are fed to the discriminator.

11. The method according to claim 9, wherein a training loss with respect to the real training data is determined, based on the distance, and wherein the training loss is used for training the generator and the discriminator of the monitoring module.

12. An apparatus method for monitoring the input data stream of an artificial intelligence (AI) module that forms part of a processing chain of a partially automated or automated driving function of a vehicle, comprising:
a monitoring module;
a generator, configured to, in a training phase, train the monitoring module using real training data and generated false training data generated by the generator;
a discriminator, configured to receive the real training data and false training data, wherein the discriminator is configured to generate a distance between the real training data and the false training data,
wherein, in an inference phase, the monitoring module is configured to evaluate the AI module and generate output signals configured for a driving function on the basis of the real input data stream,
and wherein the discriminator is configured to receive real input data, in parallel with the generated output signals to determine distances that are used for evaluating the input data stream for driving functions.

13. The apparatus according to claim 12, wherein the generated false training data is generated by a background data source that are fed to the discriminator.

14. The apparatus according to claim 12, wherein a training loss with respect to the real training data is determined, based on the distance, and wherein the training loss is used for training the generator and the discriminator of the monitoring module.

15. A method for monitoring an input data stream and an output data stream of an artificial intelligence (AI) module that forms part of a processing chain of a partially automated or automated driving function of a vehicle, comprising:
training the AI module using the real training data and ground truth data, and generating output data;
training a first monitoring module for monitoring the input data stream of the AI module using real training data and false training data, wherein the false training data are generated by a generator of a first monitoring module that generates first difference signals;
training the AI module using the output data of the AI module and false output data, wherein the false output data are generated by a generator of a second monitoring module to generate a first difference signal;
training a second monitoring module using the output data of the AI module and false output data, wherein the false output data are generated by a generator of the second monitoring module, and generating a second difference signal,
training a third monitoring module using ground truth data and false ground truth data, wherein the false ground truth data are generated by a generator of the third monitoring module), and generates a third difference signal;
monitoring, in an inference phase, both the input data stream and the output data stream from the AI module occurs, comprising
feeding the real input data stream to a discriminator of the trained first monitoring module, to determine distances therefrom that are used for evaluating the input data stream of the AI module,
feeding the output data stream to a discriminator of the trained second monitoring module, and determining via the discriminator distances therefrom that are used for evaluating the output data stream of the AI module, and/or
feeding the output data stream to a discriminator of the trained third monitoring module, and determining, via the discriminator, distances therefrom that are used for evaluating the output data stream of the AI module.

16. The method according to claim 15, wherein generating false training data comprises using a respective background data source that is which are fed to any of the discriminators of the respective monitoring modules.

17. The method according to claim 15, wherein during the training phase, training losses with respect to the respective training data are determined from each of the distances, and the training losses are used for training the generators and discriminators of the respective monitoring modules.
